(19) United States
(12) Patent Application Publication
(10) Pub. No.: US 2008/0174986 A1
(43) Pub. Date: Jul. 24, 2008

(54) PROJECTED ALPHANUMERIC LASER DISPLAY SYSTEM AND METHOD

(76) Inventor: Russell Burgess, El Paso, TX (US)

Correspondence Address: PEACOCK MYERS, P.C., 201 THIRD STREET, N.W., SUITE 1340, ALBUQUERQUE, NM, 87102, US

(21) Appl. No.: 11/841,502

(22) Filed: Aug. 20, 2007

Related U.S. Application Data
(60) Provisional application No. 60/823,238, filed on Aug. 22, 2006.
(60) Provisional application No. 60/823,073, filed on Aug. 21, 2006.

(51) Int. Cl. G01D 11/28

(52) U.S. Cl. 362/29; 362/23

(57) ABSTRACT

An alphanumeric or shaped image laser display device and method for producing a segment of an alphanumeric display or shaped image comprising a semiconductor light source for producing a beam of light, the semiconductor light source disposed in a user defined pattern within a substrate and an optical element positioned in the path of said beam of light and converting an input beam projected from said semiconductor light source into an output beam projecting to a set of predefined positions that represent a segment of an alphanumeric display or shaped image.

### CROSS-REFERENCE TO RELATED APPLICATIONS

This application claims priority to and the benefit of the filing of U.S. Provisional Patent Application Ser. No. 60/823,328, entitled PROJECTED ALPHANUMERIC LASER DISPLAY SYSTEM AND METHOD”, filed on Aug. 22, 2006, and U.S. Provisional Patent Application Ser. No. 60/823,073 entitled PROJECTED ALPHANUMERIC LASER DISPLAY SYSTEM AND METHOD”, filed on Aug. 21, 2006, and the specification and claims thereof are incorporated herein by reference.

### INTRODUCTION

The present invention relates to the field of visual displays.

### BACKGROUND OF THE INVENTION

Because of the human visual sensory system's enormous capacity to absorb and process information, visual displays are extremely effective in displaying a variety of information formats, such as, for example, moving sceneries, alphanumeric characters, and targeting data, all of which may be superimposed on a surface. The visual display can utilize a wide range of wavelengths to maximize or minimize data content to the naked eye. Particularly, tactical military operations requiring highly complex series of tasks to be performed in unpredictable environments would greatly benefit from the use of displays that are observable at wavelengths not visible to the naked eye.

Other display devices which have also been developed in an effort to replace the dominant image display device, include, for example, liquid crystal displays (LCDs), AC and DC plasma displays, thin film electro-luminescence displays, and vacuum fluorescent displays. Each of these alternative technologies, however, has fundamental shortcomings. LCDs, for example, have a very low efficiency in generating, modulating, and transmitting light. See, for example, D. L. Jose et al., “An Avionic Grey-Scale Color Head Down Display,” Proceedings of the SPIE, Vol 1289, pp 74-98 (1990). Plasma displays, on the other hand, require on the order of approximately 100 volts or more.

### SUMMARY OF THE INVENTION

One embodiment of the present invention provides an alphanumeric or shaped image laser display device comprising a semiconductor light source for producing a beam of light, the semiconductor light source disposed in a user defined pattern within a substrate; and an optical element positioned in the path of said beam of light and converting an input beam projected from said semiconductor light source into an output beam projecting to a set of predefined positions that represent a segment of an alphanumeric display or shaped image.

In another embodiment, a method of creating an alphanumeric or shaped image laser display comprises producing a beam of light from a semiconductor light source disposed in a user defined pattern within a substrate; said semiconductor light source comprising an input beam; shaping the input beam of light with an optical element positioned in the path of the beam to produce a shaped output beam; and projecting to a set of predefined positions that represent a segment of the shaped output beam to produce a segment of an alphanumeric display or shaped image.

In another embodiment, an alphanumeric or shaped image laser display device comprises a housing to house one or more light sources; a semiconductor laser light source disposed within a substrate for producing a beam of light; an optical element for converting an input beam projected from said light source into an output beam that is projected onto a target to produce a set of predefined positions that represent a segment of an alphanumeric display or shaped image; and a second optical element to further refine said output beam before projecting to said set of predefined positions that represent said segment of an alphanumeric display or character.

In a preferred embodiment, the light source is a semiconductor laser light source. In a more preferred embodiment, the light source emits light in the range selected from about 300 nm to about 2000 nm.

In a more preferred embodiment, the optical element is a beam shaper. In a more preferred embodiment, the beam shaper is a diffractive optical element. In a more preferred embodiment, the optical element is a diffuser.

In a preferred embodiment, the system and method comprises a target upon which the light is projected. In a more preferred embodiment, the target comprises an organic or inorganic coating that is phosphorescent, luminescent or fluorescent upon irradiation with the light source. In a more preferred embodiment, the light emitted or reflected from the target is in a range that is above about 740 nm and viewed by an observer through a device adapted to the above about 740 nm.

According to a preferred embodiment, a plurality of substrates are assembled together to form a user defined pattern. In a more preferred embodiment, the user defined pattern is a two dimensional array.

In a preferred embodiment, a second optical element for refining said output beam before projecting the output beam to the target is positioned in the optical path of the light beam.

It is therefore an object of the present invention to provide a visual display system that utilizes compact, solid state, high efficient, high brightness, and high contrast display devices for providing monochrome as well as full color displays to an observer's field of view.

Another aspect of the present invention provides a projection display system that will exploit available surface areas for information dissemination. For example entrances above stores in shopping malls can display current sales; caller id information can be projected on the wall of a home to enlarge the information. Other potential applications include dissemination of information at airport terminals, stadiums and theatres.

Another aspect of the display system is a system that can be projected on a surface inexpensively and does not require expensive display signs.

Another aspect of the system and method provides that the projection surface is coated with a photo emissive surface coatings for use with ultra violet and infrared lasers; photonic molecular materials, organic and polymeric materials, and/or fluorescing and phosphorescing materials.

Another aspect of the system and method provides for the projected image to be visible with a device such as night vision goggles.

Another aspect of the display system and method provides a scrolling display wherein the alphanumeric characters can be left or right scrolling, or up or down scrolling in matrix form.

Another aspect of the present invention is a laser text chip for single line, multi-line and large matrix displays.

Another aspect of the present invention provides for generating a multi segmented character or number by combining a plurality of individual segments created by limiting the light emitted by a light source to a line that corresponds to a segment of a character.

Yet another aspect provides for system that incorporates a diffuser made with grey scale lithography which obviates one or more problems or limitations of conventional on-axis diffractive optical elements.

### BRIEF DESCRIPTION OF THE DRAWINGS

FIG. 1 illustrates an optical element and light source according to one embodiment of the present invention.

FIG. 2 illustrates a layout of a light source array according to one embodiment of the present invention.

FIG. 3 illustrates segment of a light path redirected through a display device according to one embodiment of the present invention.

FIG. 4 illustrates an array according to one embodiment of the present invention.

FIG. 5 illustrates an array according to one embodiment of the present invention.

FIG. 6 illustrates an array according to one embodiment of the present invention.

FIG. 7 illustrates an array according to one embodiment of the present invention.

FIG. 8 illustrates an array according to one embodiment of the present invention.

FIG. 9 illustrates an array according to one embodiment of the present invention.

FIG. 10 illustrates a layout of a light source array according to one embodiment of the present invention.

FIG. 11 illustrates an array according to one embodiment of the present invention.

FIG. 12 illustrates an array with a plurality of light sources projecting a beam to a target according to one embodiment of the present invention.

FIG. 13 illustrates a rear projection system according to one embodiment of the present invention.

### DETAILED DESCRIPTION OF THE INVENTION

The present invention has been described in terms of preferred embodiments, however, it will be appreciated that various modifications and improvements may be made to the described embodiments without departing from the scope of the invention.

As used herein, “a” means one or more unless otherwise defined.

As used herein “beam shaper” means an optical element used to alter the shape or energy distribution of a beam of light from an input beam having a first shape into some other distribution.

As used herein “beam splitter” means an optical device for dividing a beam into two or more separate beams having the same or different characteristics.

As used herein “computer generated hologram” means a synthetic hologram produced using a computer plotter. The binary structure is formed on a large scale and is then photographically reduced. The holograms are then etched into a medium.

As used herein “diffractive optic element” means an optical element that use diffraction to control wavefronts. Diffractive optical elements include diffraction gratings, surface-relief diffractive lenses, holographic optical elements and computer-generated holograms.

As used herein “grating” means a framework or latticework having an even arrangement of rods, or any other long narrow objects with interstices between them, used to disperse light or other radiation by interference between wave trains from the interstices.

As used herein “holographic optical element” means a component used to modify light rays by diffraction; the holographic optical element “HOE” is produced by recording the interference pattern of two laser beams and can be used in place of lenses or prisms where diffraction rather than refraction is desired.

As used herein “optical element” means an optical device constructed of a piece of optical material. It is usually a single lens, prism or mirror. The optical element performs a basic optical function, i.e., the structure, when exposed to or placed in the path of a light beam, will cause refraction, diffraction, attenuation, or blocking of the light or a modification in the character.

As used herein “light source” means a device that produces a light beam including but not limited to a beam of light emitted from a semiconductor light source for example a coherent light beam.

As used herein “substrate” means a semiconductor, chip, wafer, or the material from which a semiconductor is fabricated.

One embodiment of the present invention utilizes visible emitting vertical cavity surface emitting lasers (VCSEL)s to provide a high brightness, high efficiency, information display and, more specifically, a VCSEL array display system. Particularly, the size, structure and beam qualities of the VCSELs afford high resolution monochrome or color display images, real or virtual, to be placed within an observer's field of view.

VCSELs are a class of semiconductor laser diodes that typically use a forward-biased semiconductor junction as the active medium. The semiconductor laser diode consists of a p-n junction inside a slab of semiconductor that is typically much less than a millimeter in any dimension but can be larger or smaller. Stimulated emission of coherent light occurs at a p-n junction where electrons and holes are driven into the junction. Excitation is provided by current flow through the device.

VCSELs are semiconductor lasers which, unlike conventional edge-emitting laser diodes, emit laser radiation in a direction perpendicular to the plane of the p-n junction formed therein. Different types of VCSELs are known. For example one type of VCSELs emits wavelengths from about 650 nm to about 1300 nm. Other types of VCSELs emit wavelengths with a visible laser radiation in the range between 0.4 to 0.7 μm. Some types of VCSELS emit by utilizing an active quantum well region comprising alternating layers of, for example, GaInP and AlₓGa₁₋ₓInP which are sandwiched between two distributed Bragg reflectors (DBRs) or mirrors. Some types of semiconductor light sources operate in the non-visible (infrared) wavelengths from about 0.7 μm to about 1.5 μm and others operate at wavelengths from below visibility at about 0.38 μm for near ultra violet regions. The output from these may be utilized with targets having phosphorescent, fluorescent, luminescent, chemiluminescent or bioluminescent coating or molecules associated therewith.

In operation, injection current is typically confined within an active region by the use of annular shaped proton implanted regions to achieve stimulated emission. Importantly, VCSELs may be fabricated in one- and/or two-dimensional arrays and may be integrated with optical elements such as micro-optics. With the appropriate selection of materials, each VCSEL can be made to emit laser radiation in different portions of the visible and non visible region of the electromagnetic spectrum.

According to one embodiment of the present invention, a projection device comprising one or more light sources wherein the light source may be any coherent light source, for example, VCSEL or nanocrystals, but is not limited as other types of semiconductor laser light sources will be known to one of ordinary skill in the art, produces a segment of an alphanumeric segment or a shaped image. The term alphanumeric as used can be any symbol that can be shaped by the projection device.

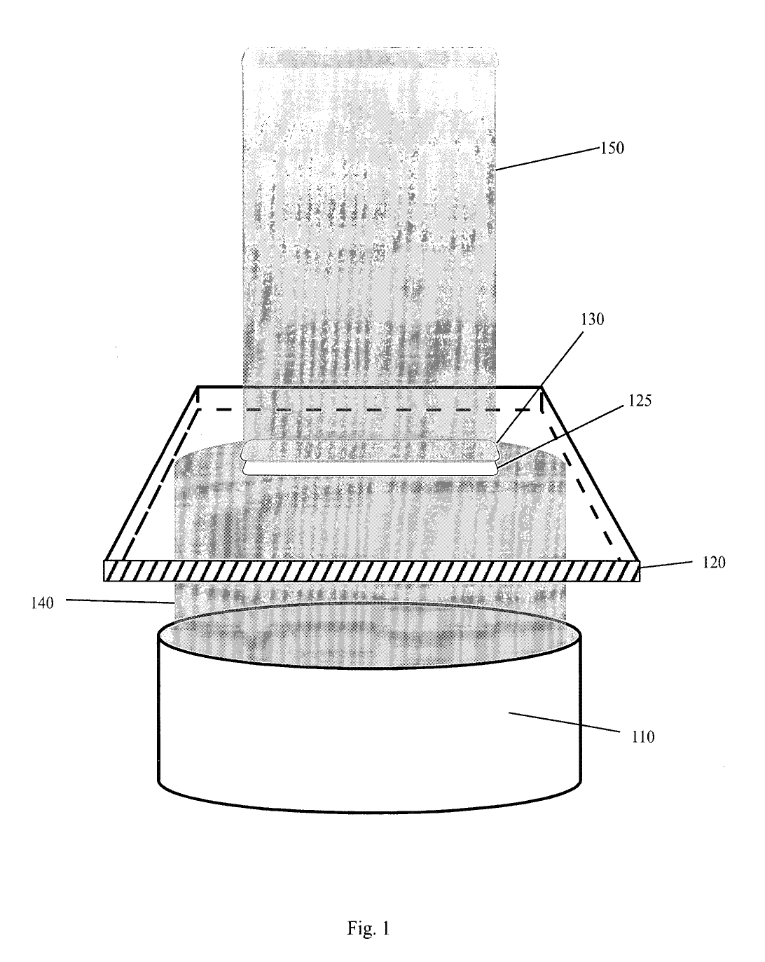

Referring now to FIG. 1, an optical element 120 having a pattern thereon 130 is positioned over a light source 110 for example VCSEL. Light beam 140 emitted from light source 110 is incoming to optical element 120. Optical element 120 redirects chosen wavelengths 150 of incoming light beam 140 to a set of predefined positions. For example the predefined position may form one segment of an alphanumeric character that is projected onto a surface in the distance. Diffusers are a type of diffractive optical element that can take a laser beam and redistribute the light into virtually any pattern desired.

In a more preferred embodiment, the optical element is integrated into the light source 110. The substrate can be any semiconductor material. The substrate can take any chip-like form. Multiple chips can be combined to create a user defined array. Multiple light sources can be arranged on each substrate in any user defined pattern.

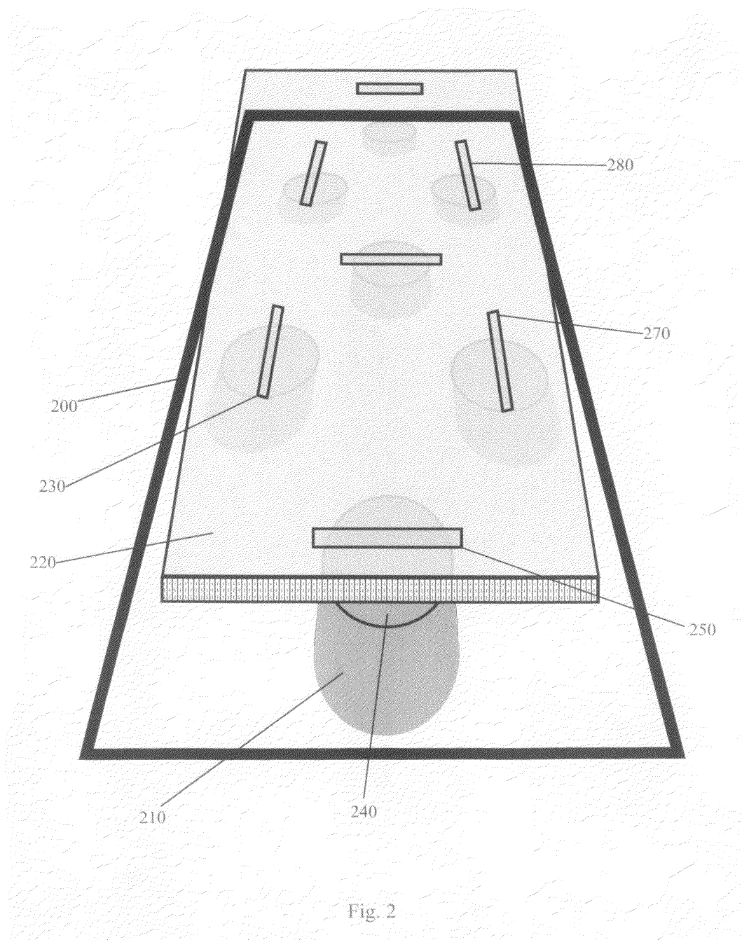

Referring now to FIG. 2, an array of 7 light sources is illustrated according to one embodiment of the present invention. Optical array support element 220 is positioned over a plurality of light sources 210 located on substrate 200 and supports multiple optical elements 230, 280 and 250 and 270. Each optical element may be the same as or different than another optical element on the optical element support. Optical element 250 is preferably a passive element that redirects incoming light emitted from a source 210 to a set of predefined positions in space.

For example, where the beam passes through the optical element 250, the beam is redefined to correspond to a segment of a multi segmented character, which when configured in proper layout of various patterns of configurations of 7, 11, 16 or 20 diodes will lend to the display of 7, 11, 16 or 20 segments when light source 210 is passed through another optical element related to the alphanumeric image being displayed. The array of the light sources are arranged according to any user defined pattern. The device is not limited to producing any one wavelength, but can generate multiple wavelengths specified by the user for example, infrared and or red. The beam may be reshaped by the optical element to any desired shape and further enhanced by optics to desired projected display size and focus. The optical element can be for example a diffractive optical element. In an alternative embodiment, the optical element is a diffuser. In a preferred embodiment the light source is the same between the plurality of light sources. In a preferred embodiment, the light sources are different. In a more preferred embodiment there is a combination of light sources within a substrate. In a preferred embodiment, the wavelength of a light source is selected from a range of about 300 nm to about 2000 nm. In a preferred embodiment, the range is about 400-750 nm. In a more preferred embodiment the range is between about 750-1500 nm. In another preferred embodiment, optical element 250 is transmissive.

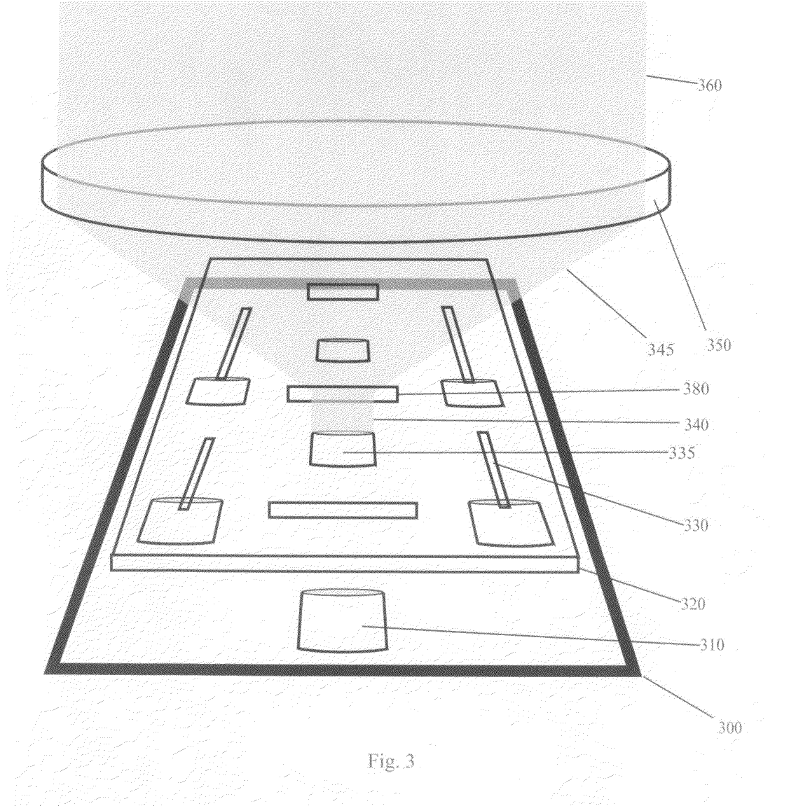

Referring now to FIG. 3 a display apparatus according to one embodiment of the present invention is illustrated. A projection device having one or more light sources 310 and 335 projects a light path 340 to an optical element 380. The incoming light path 340 is redirected 345 by the optical element 380 to a set of predefined positions for example a segment of a numeric character in a display. A lens 350 further refines the redirected beam 360 that forms a segment of the image as the beam 340 passes through the optical element 380 on its path to lens 350. The optical element 380 can also be selected for a wavelength sensitive for particular applications. Element 300 is defined as VCSEL substrate, 320 is defined as the optical element support, the addition of 360 is the final output that may still be further controlled by additional optics that would depend on application of a device as disclosed according to one embodiment of the present invention. Element 330 is another optical element for expanding the beam. The device of the present embodiment contains a power source to supply sufficient voltage and current to meet the demands of the device. LED display decoder/driver technology is readily adaptable for use with multi-segmented alphanumeric VCSEL projection technology. Voltages and current draw for some applications will nearly be identical. In a preferred embodiment, the device is a micro-optoelectronic or optoelectronic projection system.

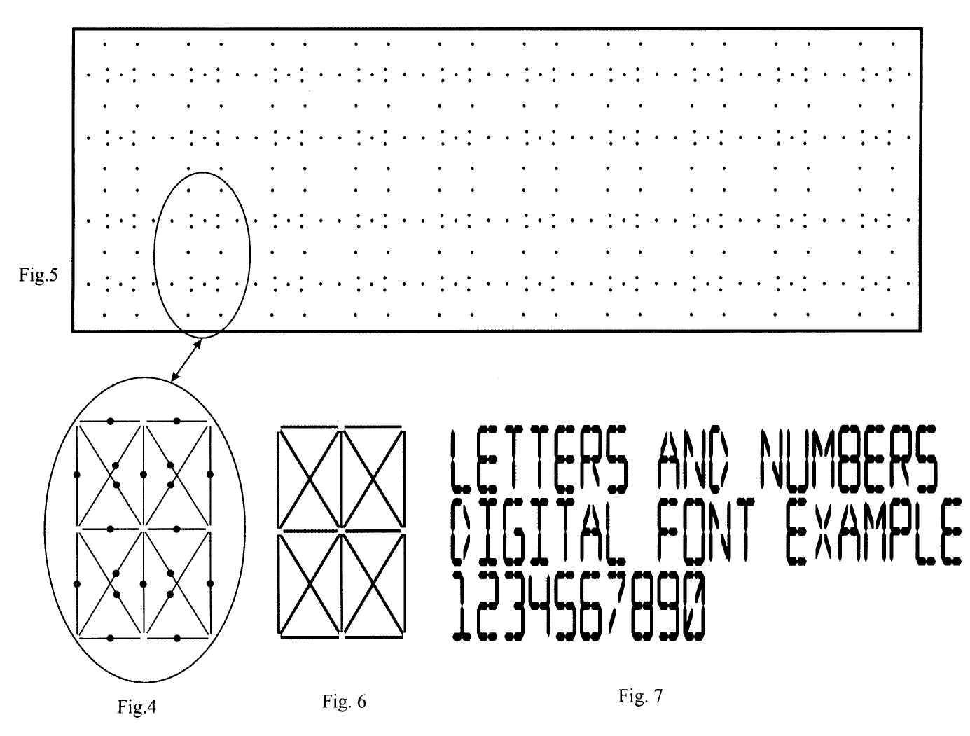

Referring now to FIG. 4, an approximate layout for a 20 segment/20 VCSEL character which can display all numbers and all characters is illustrated according to one embodiment of the present invention.

Referring now to FIG. 5 depicts an enlargement of the proposed Alphanumeric Laser Display Projection Integrated Circuit utilizing VCSEL technology in a 9×2 character array pattern. The array pattern could be manufactured to meet any desired pattern and or number of characters to meet need.

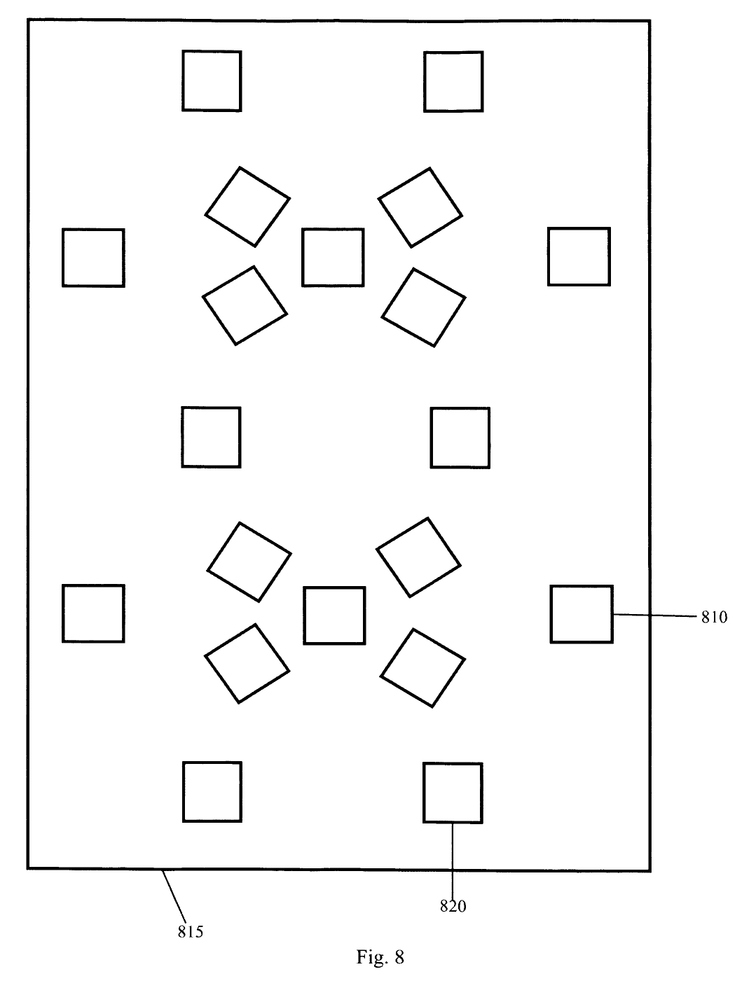

Referring now to FIG. 6 a segmented display pattern of one 20 VCSEL character if all diodes were on. The shaped segment from one or more light sources results in projecting a segment of the alphanumeric character or shaped image.

Referring now to FIG. 7 an anticipated projected display from Alphanumeric Laser Display Projection device is illustrated according to one embodiment of the present invention. However other characters or shaped images are possible such as symbols.

Referring now to FIG. 8, a 7 segment character display is illustrated according to one embodiment of the present invention. Light source as illustrated by squares such as 810 and 820 are preferably embedded in substrate 815.

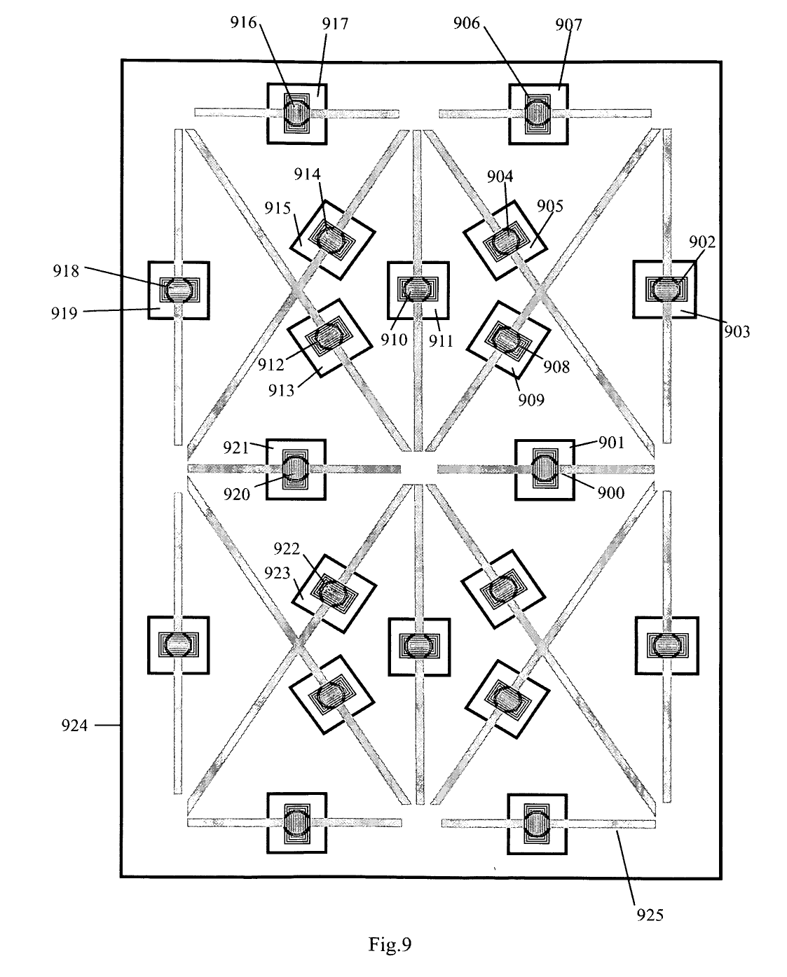

Referring now to FIG. 9, a multi character display is illustrated wherein multiple optical elements contribute to the display. Base 924 supports light source 900, 902, 904, 906, 908, 910, 912, 914, 916, 918, 920 and 922. Each light source directs a light path to an optical element that is in the light path for each light source. The base 924 may be a substrate in the case of the VCSEL wherein the substrate is a wafer. Optical element 901, 903, 905, 907, 909, 911, 913, 915, 917, 919, and 921 each redirects the incoming light they receive from an individual light source to set of predefined positions in space. For example, light source 918 projects a light path to optical element 919. Optical element 919 receives the incoming light and redirects a chosen wavelength of the incoming light to a set of predefined positions that form a segment of the number 1. When light source 916 projects a light path to optical element 917 and optical element 917 redirects the incoming light to a set of predefined positions that coordinate with a segment of a number and light source 910 projects a light path to optical element 911 and optical element 915 redirects the incoming light from light source 914 to a set of predefined positions that coordinate with a different segment of the same number, the number 7 is displayed. The pluralities of segments are illuminated via coordination of the plurality of light sources through a microprocessor according to one embodiment of the present invention. In a preferred embodiment, the light sources are individually addressable.

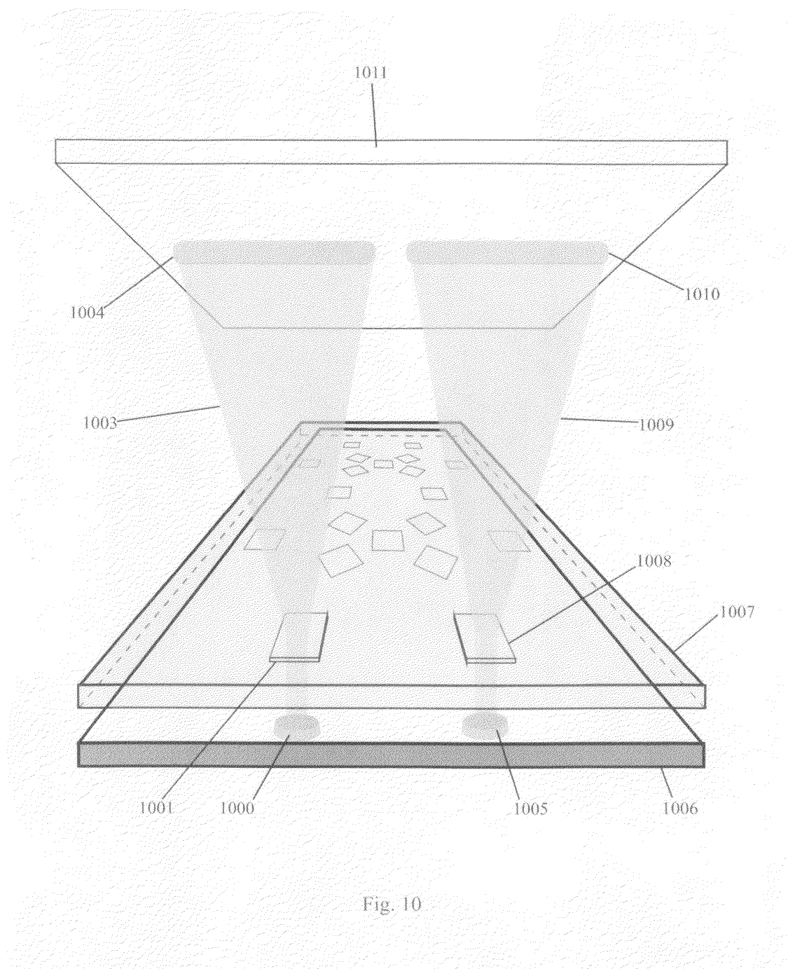

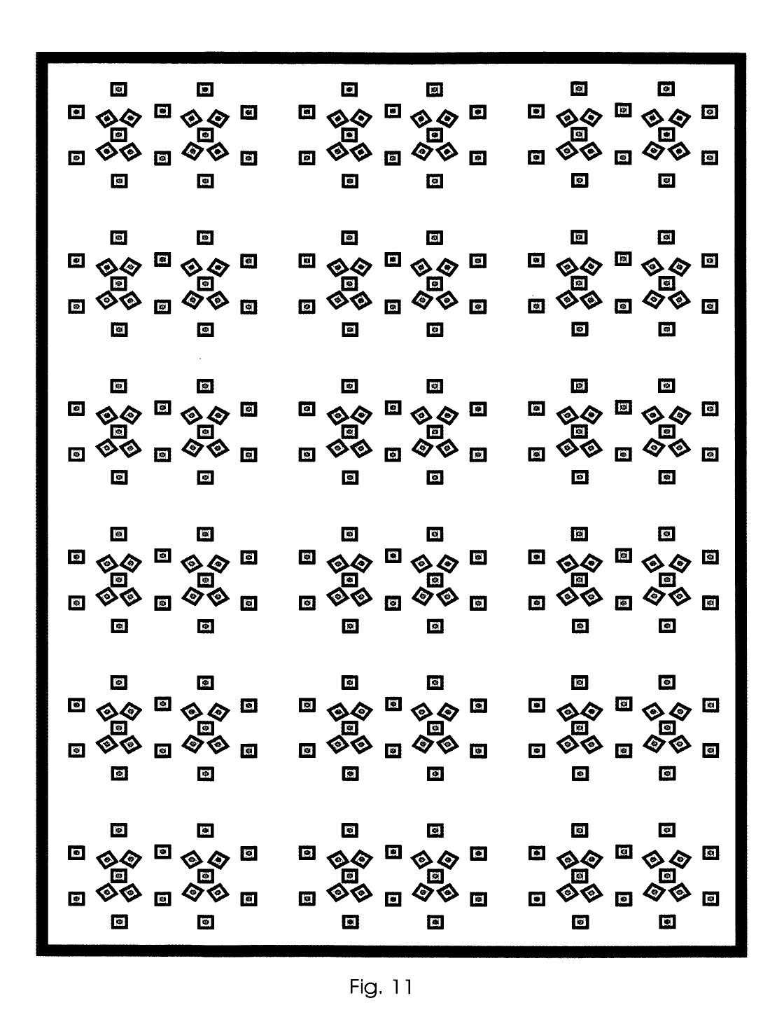

Referring now to FIG. 10, a light source array is illustrated according to one embodiment to the present invention. Characters can be displayed in an array having 20 segments and emitters. By adding additional 20 segment units on a single substrate one would have a matrix/multi-line display chip like FIG. 11. Multiple matrix chips or single character chips could be coupled together to produce nearly infinite sized arrays/displays. According to one embodiment, the light sources are 2 μm×2 μm in size and consume about 3 mW of power. Each optical element accepts incoming light projected by a separate light source. For example light source 1000 projects a light path toward optical element 1001 while light source 1005 projects a light path toward optical element 1008. A redirected beam 1003 for example is projected to a set of predefined positions 1004 on target 1011. Each optical element accepts incoming light projected by a separate light source. For example light source 1000 projects a light path toward optical element 1001 while light source 1005 projects a light path toward optical element 1008. A redirected beam 1003 for example is projected to a set of predefined positions 1004 on target 1011.

Referring now to FIG. 11, a depiction of a 3×6 character matrix where small textual information could be projected, actual matrices would probably be much larger or utilize single chip sets to form large displays is illustrated according to one embodiment of the present invention.

The light source can be a laser for example a VECSEL, NECSEL or other laser.

In displaying the desired image to the observer, each light source within an array may be individually addressed and modulated with the appropriate driver electronics. For example, information is applied to the VCSELs by individually addressing each VCSEL through the use of, for example, a matrix or row/column addressing contacts similar to those used for charged coupled device (CCD) arrays. Associated driver electronics 230, including, for example, shift registers, transistors, and the like, used for addressing and modulating the intensity of the emitted radiation may be integrated on the chip or substrate containing the VCSEL array rather than being located external to the display unit. Such integration further reduces the number of leads, allowing large arrays, e.g., 512×512, to be readily fabricated.

In accordance with the principles of the invention, VCSELs may also be integrated with, a collimated light source such as an LED to further augment and/or compliment the applicability of one embodiment of the present invention. In accordance with one embodiment of the present invention, it is contemplated that VCSELs will be integrated with SLED and/or LEDs.

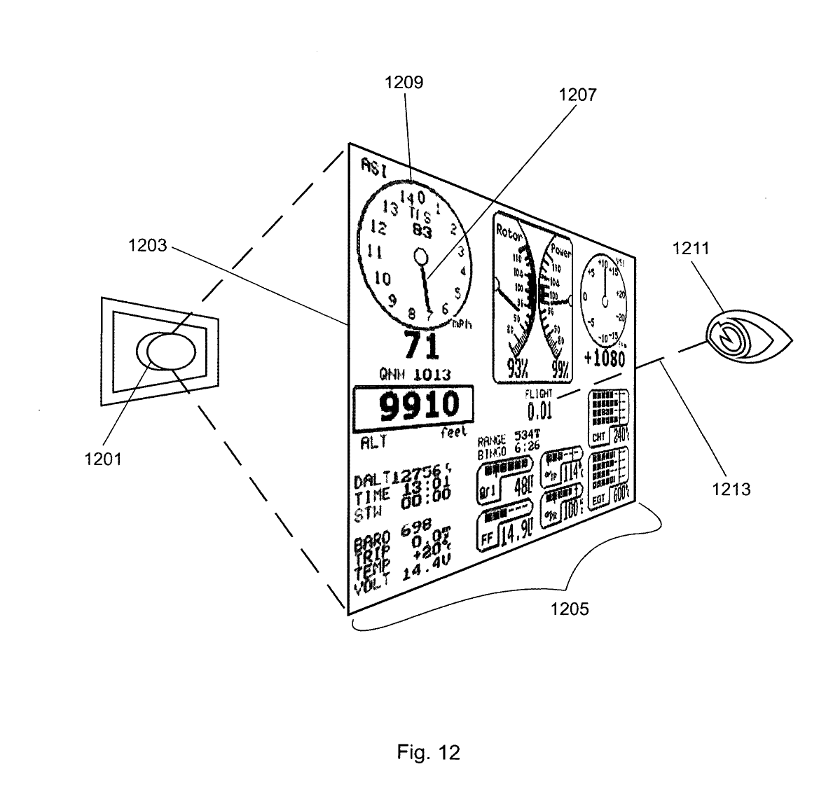

Referring now to FIG. 12, a cockpit display is illustrated according to one embodiment of the present invention. One or more light sources 1201 projects onto a target 1203 a shaped image that forms for example an instrument panel 1205. The needle 1207 on the gauge 1209 is preferably projected by a second or subsequent light source (not shown). In this manner, changes in condition can be portrayed when a third or different light source (not shown) is activated that corresponds to a change in position of the needle 1207. A zoom lens for example helps shape the beam to project on the target 1203. An optical element for example, a diffuser generated with grey scale lithography can create the shaped image 1205 as projected but is not limited thereto as other optical elements will create the same. An observer 1211 sees the shaped image on the instrument panel 1205. The light source 1201 may be infrared for example to benefit the observer who is using night vision gear and would otherwise be impaired by bright instrument panel lights. Other wavelengths are conceived such as ultraviolet wavelengths. It is also conceived that a head up display is also compatible with one embodiment of the present invention. A diffuser means a diffractive optical element that alters the output of a light source and redistributes the light into virtually any pattern defined by the user. An opaque screen may be used for rear projection system.

In a preferred embodiment the device projects the image in the absence of movable or stationary mirrors as is required by U.S. Pat. No. 7,133,022. It is an advantage to project the light beam in the absence of mirrors after the beam leaves the substrate or without any mirrors in the optical path, as mirrors require calibration. A signal processor may control the output of the light source according to feedback provided by the user or as sensed by a sensor in the target to detect for example light level or temperature. The system and method is useful not only for cockpits of aircraft but also boats, automobiles and for projection onto buildings and PDAs and specialty toys.

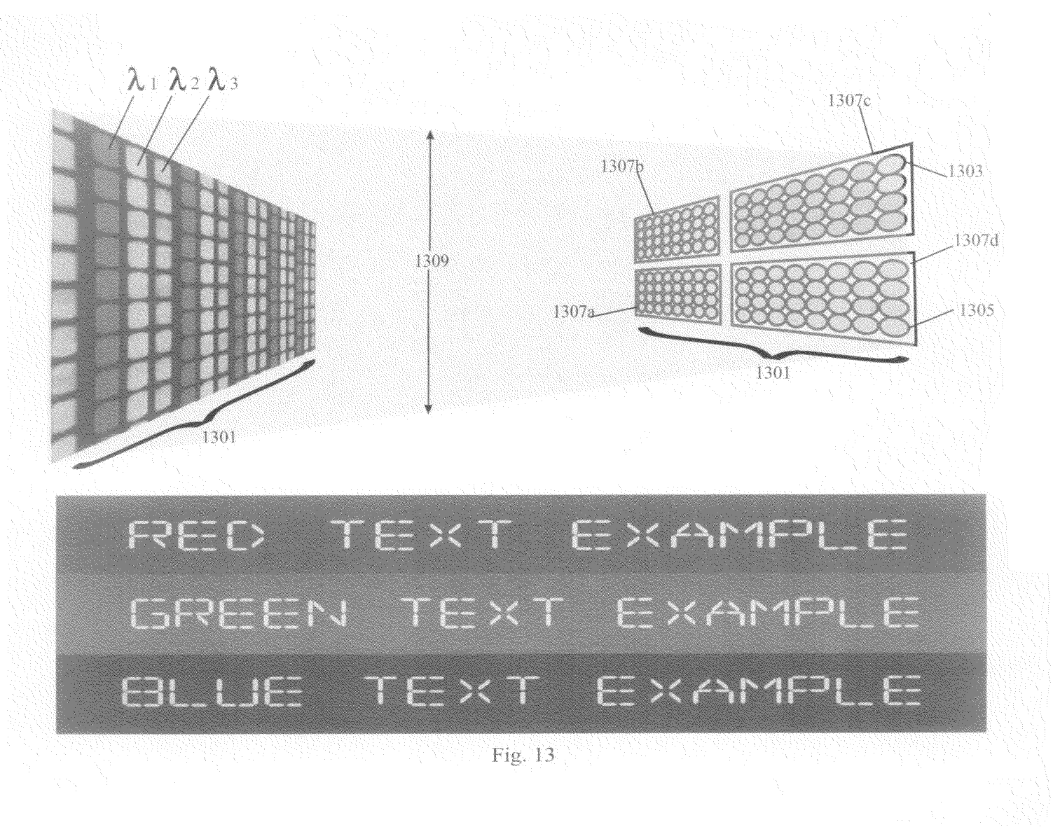

Referring now to FIG. 13, a projection device and coated target are illustrated according to one embodiment of the present invention. A projection system 1301 supports a plurality of light sources 1303-1305 on one or more substrates 1307a, 1307b, 1307c, 1307d. In a preferred embodiment the light sources are arranged in a user defined array with each light source in the array individually addressable by a controller. Each substrate may support one or more light sources that emit one or more beams of light in the same or different wavelength. The one or more beams of light 1309 strike the target 1311. The target 1311 is coated with an emissive coating such that the light emanating from the target can be the same as the wavelength of light that was projected thereon or different. For example λ1 is light having a wavelength in the about 610-635 nm range, λ2 is light having a wavelength in the about 525-540 nm range, and λ3 is light having a wavelength in the about 445-470 nm range.

The present invention has been described in terms of preferred embodiments, however, it will be appreciated that various modifications and improvements may be made to the described embodiments without departing from the scope of the invention. The entire disclosures of all references, applications, patents, and publications cited above and/or in the attachments, and of the corresponding application(s), are hereby incorporated by reference in their entirety for all purposes.

Accordingly, it is not intended that the scope of the claims appended hereto be limited to the description set forth therein, but rather that the claims be construed as encompassing all the features of patentable novelty that reside in the present invention, including all features that would be treated as equivalents thereof by those skilled in the art to which this invention pertains.

What is claimed is:

1. An alphanumeric or shaped image laser display device comprising:
a semiconductor light source for producing a beam of light, the semiconductor light source disposed in a user defined pattern within a substrate; and
an optical element positioned in the path of said beam of light and converting an input beam projected from said semiconductor light source into an output beam projecting to a set of predefined positions that represent a segment of an alphanumeric display or shaped image.

2. The device of claim 1 wherein the light source is a semiconductor laser light source.

3. The device of claim 1 wherein the optical element is a beam shaper.

4. The device of claim 3 wherein the beam shaper is a diffractive optical element.

5. The device of claim 1 wherein the optical element is a diffuser.

6. The device of claim 1 wherein the light source emits light in the range selected from about 300 nm to about 2000 nm.

7. The device of claim 1 further comprising a target upon which the light is projected.

8. The device of claim 7 wherein the target comprises an organic or inorganic coating that is phosphorescent, luminescent or fluorescent upon irradiation with the light source.

9. The device of claim 6 wherein the light emitted or reflected from the target is in the range that is above about 740 nm and viewed by an observer through a device adapted to the wavelength.

10. The device of claim 1 wherein a plurality of substrates are assembled together to form a user defined pattern.

11. The device of claim 10 wherein the user defined pattern is a two dimensional array.

12. A method of creating an alphanumeric or shaped image laser display comprising:
producing a beam of light from a semiconductor light source disposed in a user defined pattern within a substrate; said semiconductor light source comprising an input beam;
shaping the input beam of light with an optical element positioned in the path of the beam to produce a shaped output beam; and
projecting to a set of predefined positions that represent a segment of the shaped output beam to produce a segment of an alphanumeric display or shaped image.

13. The method of claim 12 wherein the light source is a semiconductor laser light source.

14. The method of claim 12 wherein the optical element is a beam shaper.

15. The method of claim 14 wherein the beam shaper is a diffractive optical element.

16. The method of claim 12 wherein the optical element is a diffuser.

17. The method of claim 12 wherein the light source emits light in the range selected from about 300 nm to about 2000 nm.

18. The method of claim 12 further comprising a target upon which the light is projected.

19. The method of claim 18 wherein the target comprises an organic or inorganic coating that is phosphorescent, luminescent or fluorescent upon irradiation with the light source.

20. The method of claim 19 wherein the light emitted or reflected from the target is in the range that is above about 740 nm and viewed by an observer through a device adapted to the wavelength.

21. The device of claim 12 wherein a plurality of substrates are assembled together to form a user defined pattern.

22. The method of claim 21 wherein the user defined pattern is a two dimensional array.

23. The method of claim 12 further comprising a second optical element for refining said output beam before projecting the output beam to the target.

24. An alphanumeric or shaped image laser display device comprising:
a housing to house one or more light sources;
a semiconductor laser light source disposed within a substrate for producing a beam of light;
an optical element for converting an input beam projected from said light source into an output beam that is projected onto a target to produce a set of predefined positions that represent a segment of an alphanumeric display or shaped image; and
a second optical element to further refine said output beam before projecting to said set of predefined positions that represent said segment of an alphanumeric display or character.
